(19) United States
(12) Patent Application Publication
(10) Pub. No.: US 2012/0302420 A1
(43) Pub. Date: Nov. 29, 2012

(54) CENTRIFUGAL DROPLET SEPARATOR FOR SEPARATING LIQUID DROPLETS OUT OF A FEED GAS STREAM COMPRISING THEM

(75) Inventors: Jörg Halpap, Mannheim (DE); Andreas Bode, Mannheim (DE); Eberhard Hermann, Frankenthal (DE); Markus Linsenbühler, Heidelberg (DE); Bernd Sachweh, Meckenheim (DE); Michael Pilz, Hemsbach (DE); Michael Mertler, Freinsheim (DE); Matthias Wilhelm Meier, Ludwigshafen (DE)

(73) Assignee: BASF SE, Ludwigshafen (DE)

(21) Appl. No.: 13/516,091

(22) PCT Filed: Dec. 13, 2010
(86) PCT No.: PCT/EP10/69521

§ 371 Date: Jun. 14, 2012

(30) Foreign Application Priority Data
Dec. 15, 2009 (EP) 09179245.7

(51) Int. Cl. B01D 45/12

(52) U.S. Cl. 494/37

(57) ABSTRACT

What is proposed is a centrifugal droplet separator for separating liquid droplets out of a feed gas stream comprising them, with a vertical longitudinal axis and circular cross section, with a jacket (1) and with hoods (2) at the upper and lower ends of the jacket (1), with tangential supply (3) of the feed gas stream comprising liquid droplets at the jacket (1) and with an outlet stub (4) for the liquid separated out in the centrifugal droplet separator in the region of the lower hood (2), and with a gas outlet stub (7) for the gas stream cleaned in the centrifugal droplet separator in the region of the upper hood (2), wherein two, three or more inlet orifices (9) arranged symmetrically on the circumference of the upper hood (2) for tangential supply of cleaning liquid are provided in the same direction as the supply of the feed gas stream comprising liquid droplets.

The invention relates to a centrifugal droplet separator for separating liquid droplets out of a feed gas stream comprising them.

Centrifugal droplet separators, also referred to as cyclones, are known in process technology and are used, for example, to separate liquid droplets out of gas streams comprising them. Centrifugal droplet separators (cyclones) are rotationally symmetric apparatuses with a generally vertical axis of rotation, frequently predominantly cylindrical apparatuses. By supplying the biphasic liquid/gas mixture to be separated tangentially, a spiral motion is imposed thereon along the inner wall of the apparatus, the components of the mixture being separated as a function of the density thereof under the action of centrifugal force. The heavier liquid droplets are separated out of the gas at the inner walls of the centrifugal droplet separator, collect in the lower region of the apparatus and are discharged through an outlet stub.

In the centrifugal droplet separator, droplets with a mean diameter of ≧5 μm are preferably separated out with a probability of 50%, and droplets with a mean diameter of ≧12 μm with a probability of >99%.

In the case of viscous and/or tacky liquids and/or liquids comprising solids which tend to encrustation, the problem may occur that the liquid droplets or the solid crusts are deposited on the inner walls of the apparatus, and no longer run off via the outlet stub, resulting in fouling combined with deteriorating separation, and finally in flooding of the apparatus.

Further apparatuses are also known for separating liquid droplets out of gas streams for low liquid loadings, which separate out liquid droplets with a mean diameter of >5 μm on the basis of inertia forces. Liquid droplets of the above size cannot follow a deflection of the gas stream, hit a barrier and are discharged from the gas stream (process gas), in some cases after coalescence with other droplets. Apparatuses in which the liquid separation follows the above principle are, for example, lamellar separators, cyclonic droplet separators or wire meshes. In these apparatuses, however, deposits may result in crust formation, such that constantly high degrees of deposition cannot be achieved over a prolonged period, because the elements of relevance for the deposition are deactivated or blocked by deposits within a very short time.

In general, discontinuous or else continuous cleaning of the above-described apparatuses is effected by spraying in a cleaning liquid by means of spray nozzles. However, successful cleaning is not always ensured since solids become trapped in protected areas, for example in collecting grooves in lamellar separators or in a wire mesh, and therefore frequently cannot be discharged. In addition, the cleaning liquid has to be dispersed in the gas stream and also separated out of it again.

It was therefore an object of the invention to provide a centrifugal droplet separator for the separation of liquid/gas mixtures, which does not have the above disadvantages.

The object is achieved by a centrifugal droplet separator for separating liquid droplets out of a feed gas stream comprising them, with a vertical longitudinal axis and circular cross section, with a jacket and with hoods at the upper and lower ends of the jacket, with tangential supply of the feed gas stream comprising liquid droplets at the jacket and with an outlet stub for the liquid separated out in the centrifugal droplet separator in the region of the lower hood, and with a gas outlet stub for the gas stream cleaned in the centrifugal droplet separator in the region of the upper hood, wherein two, three or more inlet orifices arranged symmetrically at the periphery of the upper hood for tangential supply of cleaning liquid are provided in the same direction as the supply of the feed gas stream comprising liquid droplets.

The liquid preferably runs over an edge in order that complete wetting of the wall with cleaning liquid is achieved.

It has been found that substantially unhindered runoff even of liquids which are highly viscous and/or tacky and/or comprise one or more solids is possible, and that it is possible to substantially or completely prevent the deposition of liquid, especially of high-viscosity and/or tacky liquid, on the inner walls of the centrifugal droplet separator by introducing a cleaning liquid during operation at the upper end thereof, in the same direction as the supply of the feed gas stream which comprises liquid droplets and is to be separated. By introducing the cleaning liquid tangentially in accordance with the invention, and hence onto the inner walls of the apparatus, it is passed directly into the areas where the liquid separates out of the mixture to be separated, and need not first be removed from the mixture. This increases efficiency and leads to a lower energy consumption overall, since complete wetting of the wall achieves, dry sites on the wall are avoided and hence crust formation is prevented.

The cleaning liquids used are especially liquids which can be removed again easily from the liquid to be removed from the feed gas stream, and which more particularly do not react chemically with said liquid.

The cleaning liquids used may also be solvents for the liquid to be removed from the feed gas stream or the same liquid which is to be removed from the feed gas stream.

The cleaning liquid can be used with or without additives.

The cleaning liquid can also enter into a reaction, a chemisorption or else a physisorption.

The cleaning liquid used may preferably be water.

The inlet orifices for the cleaning liquid may have a circular cross section. In a preferred embodiment, the inlet orifices for the cleaning liquid are configured with a rectangular cross section.

In a preferred embodiment, the lower hood narrows in a frustoconical manner towards the outlet stub. This geometric configuration facilitates the runoff of the liquid separated out.

The steepness of the frustocone should be selected such that the liquid runs off freely, i.e. a relatively high steepness in the case of relatively high viscosity of the liquid. For instance, in the case of high-viscosity liquids, for example with the viscosity of honey, the cone is very steep. For substances with water-like viscosity which run off readily, no cone is required. For the removal of such liquids, the lower hood may also be flat or may be configured as a dished end.

In a further preferred embodiment, an apex cone, which may preferably—for reasons of simpler manufacture—be open at the bottom, is arranged at the base of the lower hood, and metal sheets are arranged radially and perpendicularly to the base at the base of the lower hood, which support homogeneous runoff of the liquid and as far as possible do not disrupt the flow of the mixture to be separated in the apparatus. In this way, vortices which do not run off are avoided.

The diameter of the apex cone is advantageously matched to the internal diameter of the centrifugal droplet separator. The apex cone preferably has a diameter corresponding to 0.6 to 0.8 times the internal diameter of the centrifugal droplet separator. The angle in the tip of the apex cone is preferably between 100 and 130°. However, plate-shaped embodiments—without an apex cone—are also possible.

The metal sheets arranged radially and perpendicularly to the base at the base of the lower hood function more particularly as baffles.

In a further preferred embodiment, at a drip skirt open at the bottom, arranged around the gas outlet stub in the region of the upper hood, liquid droplets are separated out of the gas stream which leaves via the outlet stub and drip back into the apparatus.

The drip skirt preferably has a length corresponding to 1.2 times the length of the gas outlet stub projecting into the apparatus.

The upper hood, at the periphery of which two, three or more inlet orifices for a tangential supply of cleaning liquid are provided, advantageously widens in the manner of a frustocone with respect to the circumference of the jacket, forming, at the transition between the jacket and the upper hood, an edge over which the cleaning liquid runs.

The invention also provides a process for removing liquid droplets from a feed gas stream comprising them in a centrifugal droplet separator with a vertical longitudinal axis and circular cross section, with a jacket and with hoods at the upper and lower ends of the jacket, with at least one tangential supply of the feed gas stream comprising liquid droplets at the jacket and with an outlet stub for the liquid separated out in the centrifugal droplet separator in the region of the lower hood, and with a central gas outlet stub for the gas stream cleaned in the centrifugal droplet separator in the region of the upper hood, wherein a cleaning liquid is introduced, in the region of the upper hood, via two, three or more inlet orifices arranged symmetrically at the periphery thereof, tangentially and in the same direction as the feed gas stream comprising liquid droplets.

The cleaning liquid can be supplied continuously, over the entire duration of supply of the feed gas stream to be separated.

In a further embodiment of the process, the cleaning liquid is supplied discontinuously, at time intervals.

The invention is illustrated in detail hereinafter with reference to a drawing.

The specific figures show:

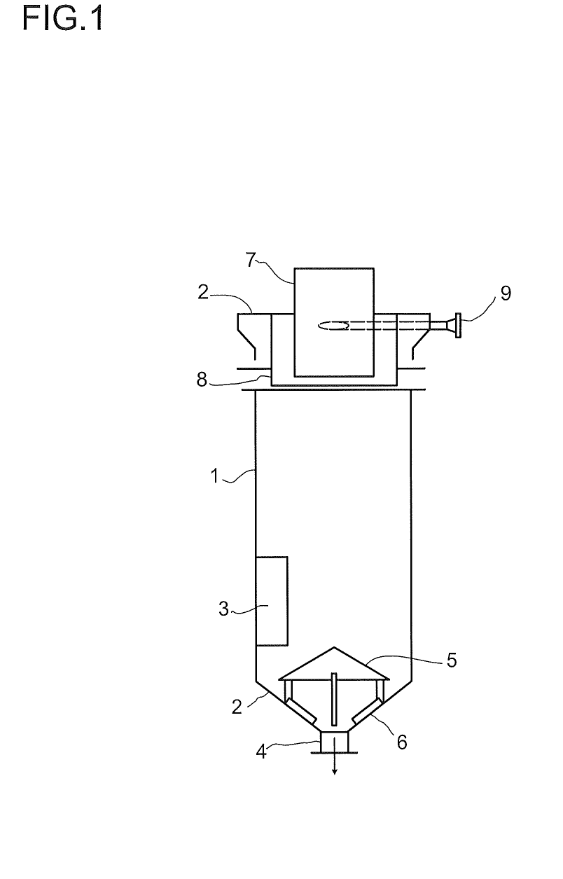

FIG. 1 a schematic diagram of an inventive centrifugal droplet separator in longitudinal section and

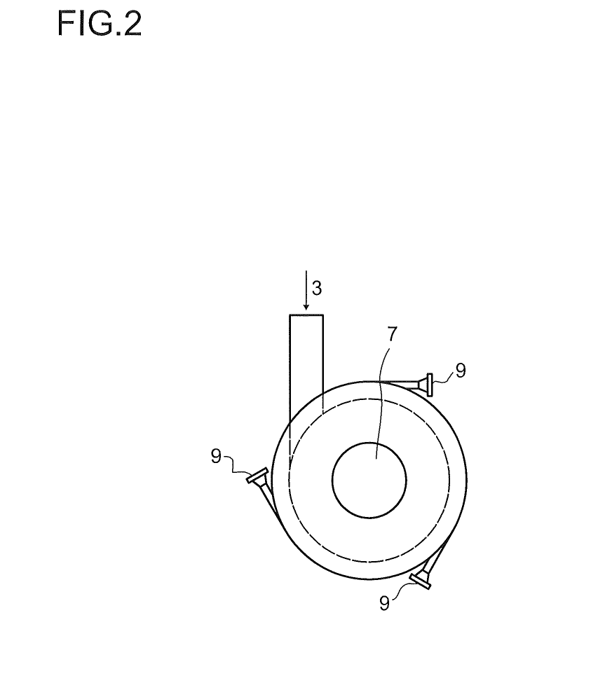

FIG. 2 a cross section through one embodiment of an inventive centrifugal droplet separator in the region of the inlet orifices for the cleaning liquid.

The longitudinal section diagram in FIG. 1 shows one embodiment of an inventive centrifugal droplet separator with jacket 1 and hoods 2 at the upper and lower ends of the jacket 1, and with tangential supply 3 for the feed gas stream.

The liquid separated out in the centrifugal droplet separator is removed via an outlet stub 4 in the region of the lower hood 2, and the cleaned gas stream via a gas outlet stub 7 in the region of the upper hood 2.

In the preferred embodiment shown in the figure, an apex cone 5, open at the bottom by way of example, is arranged in the region of the lower hood 2, and, at the base of the lower hood 2, perpendicularly thereto, metal sheets 6 aligned radially. In the region of the upper hood 2, around the gas outlet stub 7, is provided a drip skirt 8 which is open at the bottom. In the longitudinal section diagram in FIG. 1, a tangentially arranged inlet orifice 9 for a cleaning liquid is identifiable in the region of the upper hood 2.

The cross-sectional diagram in FIG. 2 shows the inlet orifices 9 for a cleaning liquid, three orifices by way of example, arranged tangentially in the region of the upper hood 2. In the figure, the tangential supply 3 and the central gas outlet stub 7 are likewise identifiable.

1-5. (canceled)

6. A process for separating liquid droplets out of a feed gas stream comprising them in a centrifugal droplet separator with a vertical longitudinal axis and circular cross section with a jacket and with hoods at the upper and lower ends of the jacket, with tangential supply of the feed gas stream comprising liquid droplets at the jacket and with an outlet stub for the liquid separated out in the centrifugal droplet separator in the region of the lower hood, and with a gas outlet stub for the gas stream cleaned in the centrifugal droplet separator in the region of the upper hood, wherein a cleaning liquid is supplied via two, three or more inlet orifices arranged tangentially and symmetrically at the periphery of the upper hood, in the same direction as the feed gas stream comprising liquid droplets.

7. The process according to claim 6, wherein the cleaning liquid is supplied continuously.

8. The process according to claim 6, wherein a centrifugal droplet separator is used, wherein an apex cone and, at the base of the lower hood, metal sheets arranged radially and perpendicularly to the base are provided over the outlet stub.

9. The process according to claim 6, wherein a centrifugal droplet separator is used, wherein a drip skirt open at the bottom, arranged around the gas outlet stub in the region of the upper hood is provided at which liquid droplets are separated out of the gas stream which leaves via the gas outlet stub.

10. The process according to claim 6, wherein a centrifugal droplet separator is used, wherein the upper hood, at the periphery of which two, three or more inlet orifices for a tangential supply of cleaning liquid are provided, widens in the manner of a frustocone with respect to the circumference of the jacket, forming, at the transition between the jacket and the upper hood, an edge over which the cleaning liquid runs.
